(19) United States
(12) Patent Application Publication
(10) Pub. No.: US 2016/0159621 A1
(43) Pub. Date: Jun. 9, 2016

(54) WEIGHT LIFTING SYSTEM

(71) Applicant: Caterpillar Inc., Peoria, IL (US)

(72) Inventor: Kenneth Stonecipher, Metamora, IL (US)

(73) Assignee: Caterpillar Inc., Peoria, IL (US)

(21) Appl. No.: 15/018,894

(22) Filed: Feb. 9, 2016

(51) Int. Cl. B66C 13/22; B66C 23/16

(52) U.S. Cl. CPC B66C 13/22; B66C 23/16

(57) ABSTRACT

A weight lifting system disclosed. The weight lifting system includes a jib crane having a boom member. The weight lifting system includes a holding assembly. The holding assembly is coupled with the boom member. The weight lifting system includes a robotic assembly. The weight lifting system also includes an electric motor coupled with the holding assembly. The electric motor includes an octal encoder and a processing unit configured to determine an interpolation based on an octal interpolation phasing. The weight lifting system further includes a control module communicably coupled to the electric motor and the robotic assembly. The control module is configured to control the electric motor and the robotic assembly based on the interpolation determined by the octal encoder and the processing unit.

### TECHNICAL FIELD

The present disclosure relates to a weight lifting system, and more particularly to a weight lifting system implemented at a worksite.

### BACKGROUND

A crane is generally used at a worksite for lifting and lowering of loads vertically, and also for moving the loads horizontally. The crane is equipped with a holding assembly, an electric motor, and a horizontal load supporting boom that is attached to a vertical column. The crane may be operated by personnel at the worksite. Multiple functions of the crane are controlled by at least one of a human machine interface, mechanical levers, joy sticks, and the like. At times, the interface between the personnel and the crane is intuitive and fails to give an accurate position of the crane at the worksite. This may result in undershooting/overshooting of the crane. The undershooting/overshooting of the crane causes a cable of the crane to sway leading to inefficient, unsafe, and inaccurate operation of the crane. As a result effectiveness of the crane is compromised.

Further, at some worksites, industrial robots are employed to perform weight lifting functions. The industrial robots employed in the worksite may be light industrial robots such as cobots. However, the industrial robots have limited weight lifting capabilities. In some examples, the industrial robots can lift a load of approximately 22 lbs. Although the industrial robots are very attractive from a cost point and a programming point, the industrial robots have limited capability at the worksite.

U.S. Pat. No. 4,260,941, hereinafter referred to as the '941 patent, describes a programmable automatic assembly system to assemble small parts. Each assembly station includes cooperating manipulator arms which are programmable to assemble parts on a centrally located work table. The said facilities are provided for teaching the manipulator arms at each station. The said facilities include a computer to assist the teaching operator in setting up the programs required for assembly of small parts to close tolerances. Each of the manipulator arms include closed loop teach facilities for maintaining the arm at a previously located position during the teaching mode of operation. The computer is employed as a teach assist facility in performing a number of tasks during the teaching operation that are extremely difficult for the operator to perform manually. All of the assembly stations are controlled during playback from a common disc storage facility so that the control circuitry and memory storage facilities at each manipulator are minimized. However, the '941 patent does not disclose a combination of a manipulator arm and the crane for eliminating inaccuracies in the operation of the crane.

### SUMMARY OF THE DISCLOSURE

In one aspect of the present disclosure, a weight lifting system is provided. The weight lifting system includes a jib crane. The jib crane has a boom member. The boom member includes a first end connected to a supporting member of the jib crane and a second end spaced apart from the first end. The weight lifting system also includes a holding assembly. The holding assembly is coupled with the boom member and adapted to move between the first end and the second end of the boom member. The weight lifting system further includes a robotic assembly. The robotic assembly is operatively coupled with the holding assembly. The robotic assembly is adapted to enable the movement of the holding assembly between the first end and the second end. The weight lifting system includes an electric motor coupled with the holding assembly. The electric motor is adapted to enable a lifting function of the holding assembly. The electric motor includes an octal encoder and a processing unit for determining an interpolation based on an octal interpolation phasing. The weight lifting system further includes a control module. The control module is communicably coupled to the electric motor and the robotic assembly. The control module adapted to control the electric motor and the robotic assembly based on the interpolation determined by the octal encoder and the processing unit.

Other features and aspects of this disclosure will be apparent from the following description and the accompanying drawings.

### BRIEF DESCRIPTION OF THE DRAWINGS

FIG. 1 is a schematic diagram of a weight lifting system, according to an embodiment of the present disclosure;

FIG. 2 is a block diagram of the weight lifting system having a robotic assembly;

FIG. 3 is a detailed block diagram of an electric motor and a control module of the weight lifting system of FIG. 2; and

FIG. 4 is a table representing data for a hybrid Gray encoder and an octal interpolation phasing, according to an embodiment of the present disclosure.

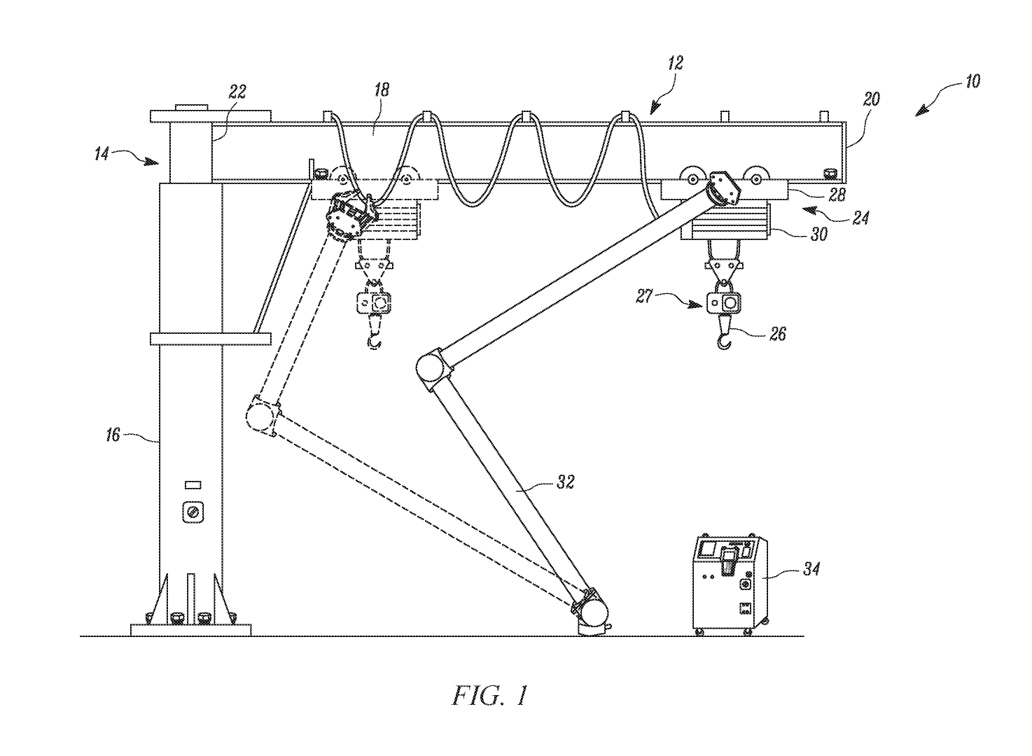

### DETAILED DESCRIPTION

Wherever possible, the same reference numbers will be used throughout the drawings to refer to the same or the like parts. FIG. 1 illustrates a schematic diagram of a weight lifting system 12 located at a worksite 10, according to an embodiment of the present disclosure. The weight lifting system 12 includes a jib crane 14. The jib crane 14 is used for lifting and lowering of loads vertically, and also for moving the loads horizontally. The jib crane 14 includes a supporting member 16. In the illustrated example, the supporting member 16 is a vertical, free standing structure. However, in one example, the supporting member 16 may embody a building. The jib crane 14 includes a boom member 18. The boom member 18 may be a horizontal load supporting boom. The boom member 18 and the supporting member 16 are substantially perpendicular to each other.

The boom member 18 includes a first end 20 and a second end 22. The supporting member 16 is coupled to the boom member 18. The jib crane 14 includes a holding assembly 24. The holding assembly 24 includes a lifting hook 26 attached to a pulley mechanism 27. The lifting hook 26 and the pulley mechanism 27 may embody elements known in the art that are used for lifting loads. The holding assembly 24 further includes a trolley 28. The trolley 28 is movably connected to the boom member 18. The trolley 28 allows movement of the holding assembly 24 along a length of the boom member 18. More particularly, the trolley 28 allows the holding assembly 24 to move between the first end 20 and the second end 22 of the boom member 18. It should be noted that the holding assembly 24 may include multiple components for enabling movement of the load, without limiting the scope of the present disclosure.

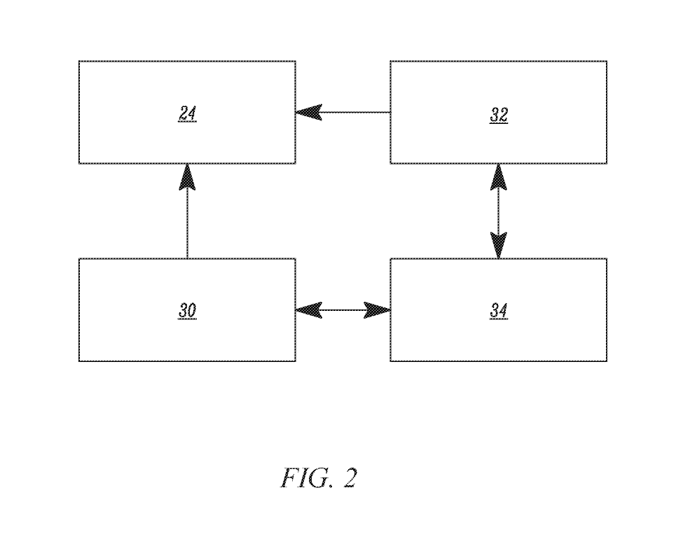

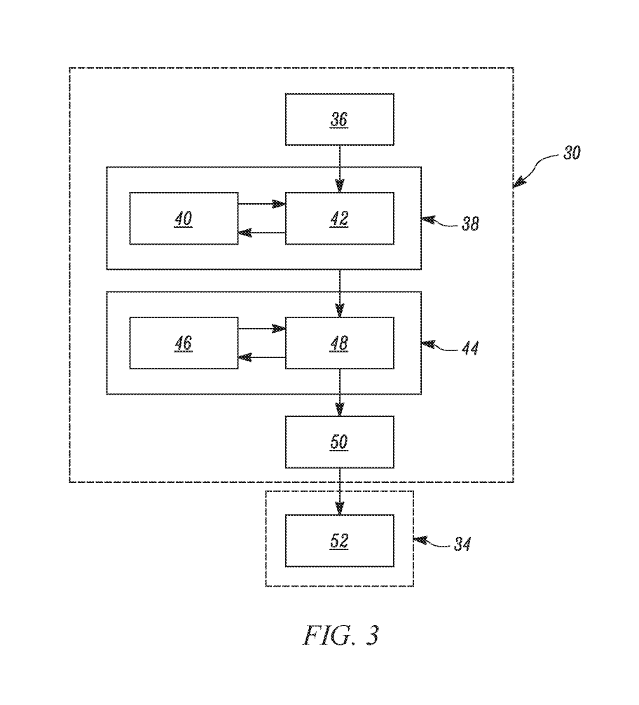

Referring to FIGS. 1 and 2, the weight lifting system 12 further includes an electric motor 30. The electric motor 30 is communicably coupled to the holding assembly 24. A lifting function of the lifting hook 26 of the holding assembly 24 may be enabled by the electric motor 30. Multiple constructional features and functional features of the electric motor 30 will be explained in detail with reference to FIG. 3.

The weight lifting system 12 further includes a robotic assembly. 32. The robotic assembly 32 is operatively connected to the trolley 28 of the holding assembly 24. The robotic assembly 32 may be programmed using a programming interface to move the holding assembly 24. The robotic assembly 32 and the electric motor 30 are in communication with a control module 34. Further, the control module 34 is in communication with the electric motor 30 and the robotic assembly 32, via a communication network. The communication network may embody any known in the art network that allows communication of the control module 34 with the electric motor 30 and the robotic assembly 32, without limiting the scope of the present disclosure. In one example, the control module 34 may be a Programmable Logic Controller (PLC). The control module 34 may be located at the worksite 10 and/or a remote control room (not shown).

During operation of the weight lifting system 12, the movement of the holding assembly 24 is controlled by the robotic assembly 32 and the electric motor 30. In order to lift the load, the lifting hook 26 of the holding assembly 24 may have a downward movement and an upward movement. The downward movement and the upward movement of the lifting hook 26 are referred to as a vertical movement of the lifting hook 26 hereinafter. The vertical movement of the lifting hook 26 is enabled using the electric motor 30. The electric motor 30 may actuate the pulley mechanism 27 for enabling the vertical movement of the lifting hook 26. The control module 34 controls the vertical movement of the lifting hook 26 by controlling the electric motor 30.

Further, the movement of the holding assembly 24 between the first end 20 and second end 22 of the boom member 18 is referred to as a horizontal movement of the holding assembly 24. The robotic assembly 32 also enables the horizontal movement of the holding assembly 24. The control module 34 controls the horizontal movement of the holding assembly 24 by communicating with the robotic assembly 32.

Referring to FIG. 3, a block diagram of components of the electric motor 30 and the control module 34 of the weight lifting system 12 is illustrated. The electric motor 30 includes an octal encoder 36. The octal encoder 36 is configured based on an octal interpolation phasing. The octal interpolation phasing may include a method of determining multiple phases on the rotor of the electric motor 30 based on an octal number system. In one example, the octal encoder 36 implemented in the weight lifting system 12 is an octal based hybrid Gray encoder. Hence, the output of the octal encoder 36 is an octal code. The octal encoder 36 includes a rotor plate (not shown) aligned with a rotor (not shown) of the electric motor 30. The rotor plate rotates along with the rotor of the electric motor 30. A light source is located at one side of the rotor plate and a photodetector (not shown) is located at an opposite side of the rotor plate. The rotation of the rotor plate is detected by the photodetector based on a pre-defined pattern provided in the rotor plate. The pre-defined pattern may include multiple contact portions that are defined for generating a Gray code corresponding to the octal code. Thus, signals generated at the photodetector correspond to the rotation of the rotor plate.

The signals generated at the photodetector are sent to a signal conditioning module 38. The signal conditioning module 38 includes an amplifier 40. The amplifier 40 amplifies the signal received from the photodetector. The signal conditioning module 38 also includes a pre-filter 42. The amplified signals are sent to the pre-filter 42. The pre-filter 42 filters signal noise and disturbance in the received signal. The pre-filter 42 may include any known that eliminates signal noise and disturbances in a signal.

The electric motor 30 includes a processing unit 44. The processing unit 44 of the electric motor 30 is configured based on the octal interpolation phasing. Further, the signal from the signal conditioning module 38 is fed in to the processing unit 44. The processing unit 44 includes a phase detector 46 and a computation unit 48. The phase detector 46 determines the phase of the signal based on a set of calculations performed by the computation unit 48. The computation unit 48 is configured to perform calculations corresponding to the octal interpolation phasing.

The electric motor 30 further includes an octal phase interpolator module 50. An output of the processing unit 44 is sent to the octal phase interpolator module 50. The octal phase interpolator module 50 identifies a vertical position of the lifting hook 26 based on the output of the processing unit 44. The octal phase interpolator module 50 is configured based on the octal interpolation phasing. The octal phase interpolator module 50 is communicably coupled to the control module 34. The control module 34 includes a robot control input output module 52. The robot control input output module 52 receives the information regarding the vertical position of the lifting hook 26. Also, the robot control input output module 52 enables communication between the control module 34 and the robotic assembly 32. In one example, the robotic assembly 32 may be configured based on decimal number system and the control module 34 is configured based on octal based number system. In such scenarios, the robot control input output module 52 is enabled to establish a communication between the robotic assembly 32 and the control module 34. The control module 34 coordinates the horizontal movement of the holding assembly 24 over the boom member 18 using the robotic assembly 32.

During an operation of the weight lifting system 12, the electric motor 30 enables the lifting hook 26 to move upwards and/or downwards for lifting the load. The processing unit 44 monitors the vertical position of the lifting hook 26 based on the octal encoder 36. The monitored vertical position is communicated to the control module 34. Once, the load is lifted up to a desired vertical position, the control module 34 communicates with the robotic assembly 32 for initiating the horizontal movement of the holding assembly 24.

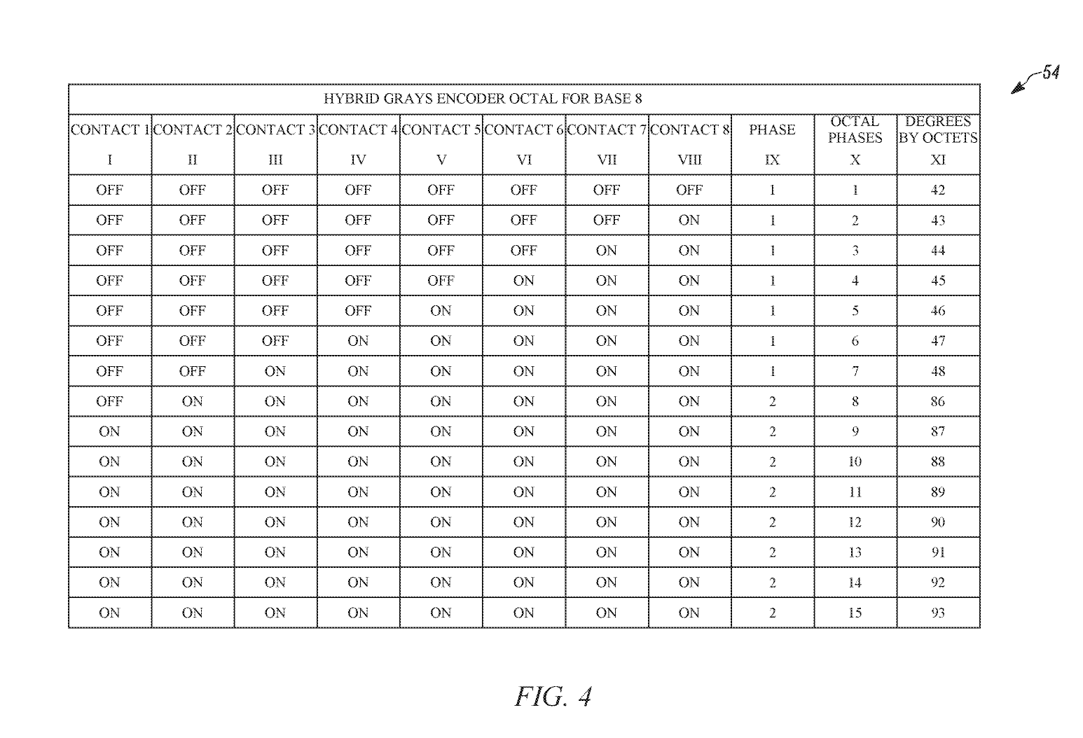

FIG. 4 is a table 54 representing the hybrid Gray encoder and the octal interpolation phasing based on the Gray code. Column I to column VII of the table 54 indicates states of each of the contact portion of the photodetector during operation of the electric motor 30. The state of the contact portion may be determined based on the pulsed signals generated by the photodetector. The state of the contact portion is “ON” and “OFF”. This enables determining of the phase of the electric motor 30. The phase of the electric motor 30 is given at column VI. Further, a corresponding octal phase for the phase determined at column VI is determined based on a state of each of the contact portion. The corresponding octal phase is given at column X. Further, a degree of rotation of the rotor of the electric motor 30 is determined using the octal base phase interpolation. The same is provided at column IX.

In one example, the state of contact portions of the rotor plate at column I is “ON”, column II is “ON”, column III is “ON”, column IV is “ON”, column V is “OFF”, column VI is “ON”, ”, column VII is “ON”, and column IIX is “ON”. The phase of the electric motor 30 determined based on aforementioned states is 2. The same is given at column IX. The octal phase for the corresponding state is 9, which is given at column X. Further, the degree of rotation of the motor is 87 degrees. In another example, the state of contact portions at column I is “ON”, column II is “ON”, column III is “ON”, column IV is “ON”, column V is “ON”, column VI is “ON”, column VII is “OFF”, and column IIX is “OFF”, then, the phase at column IX is 2. The octal phase is 15 column X and the degree of rotation of the electric motor 30 is 93 degrees at column XI.

### INDUSTRIAL APPLICABILITY

The present disclosure relates to the weight lifting system 12. The weight lifting system 12 incorporates the robotic assembly 32 and the jib crane 14. The combination of the robotic assembly 32 and the jib crane 14 in the weight lifting system 12 increases lifting capabilities of the jib crane 14. In some examples, the lifting capacity of the weight lifting system 12 may be increased to approximately 2000 lbs. Further, the weight lifting system 12 implements octal interpolation phasing, which reduces target errors, sensor errors, precision errors, signal conditioning errors, interpolation errors, output jitters, overshoot and undershoot errors, thereby increasing reliability of the weight lifting system 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A weight lifting system comprising:
a jib crane having a boom member, wherein the boom member includes a first end connected to a supporting member of the jib crane and a second end spaced apart from the first end;
a holding assembly coupled with the boom member and adapted to move between the first end and the second end of the boom member;
a robotic assembly operatively coupled with the holding assembly and adapted to enable the movement of the holding assembly between the first end and the second end;
an electric motor coupled with the holding assembly and adapted to enable a lifting function of the holding assembly, wherein the electric motor includes an octal encoder and a processing unit adapted to determine an interpolation based on an octal interpolation phasing; and
a control module communicably coupled to the electric motor and the robotic assembly, the control module adapted to control the electric motor and the robotic assembly based on the interpolation determined by the octal encoder and the processing unit.
